(19) United States
(12) Patent Application Publication
(10) Pub. No.: US 2026/0244990 A1
(43) Pub. Date: Aug. 20, 2026

(54) CHANNEL MODEL ESTIMATION SYSTEM AND METHOD

(71) Applicant: ULAK HABERLESME ANONIM SIRKETI, Ankara (TR)

(72) Inventors: Evren TUNA, Ankara (TR); Huseyin ARSLAN, Istanbul (TR)

(73) Assignee: ULAK HABERLESME ANONIM SIRKETI, Ankara (TR)

(21) Appl. No.: 19/472,102

(22) PCT Filed: Apr. 4, 2024
(86) PCT No.: PCT/TR2024/050355

§ 371 Date: Oct. 3, 2025

(30) Foreign Application Priority Data
Apr. 7, 2023 (TR) 2023/003855

(51) Int. Cl. G06N 20/00; H04W 24/08

(52) U.S. Cl. CPC G06N 20/00; H04W 24/08

(57) ABSTRACT

A method for estimating channel model of a wireless communication system includes the steps of receiving and recording predetermined metrics over a first time period; processing recorded metrics using a machine learning algorithm to predict metrics for a second time period that is later than the first time period; accessing a database having predetermined metric thresholds; and determining a channel model based on metric thresholds and future metrics using a classifier algorithm.

### CROSS REFERENCE TO THE RELATED APPLICATIONS

This application is the national phase entry of International Application No. PCT/TR2024/050355, filed on Apr. 4, 2024, which is based upon and claims priority to Turkish Patent Application No. 2023/003855, filed on Apr. 7, 2023, the entire contents of which are incorporated herein by reference.

### TECHNICAL FIELD

The present disclosure relates generally to wireless communication systems and, more particularly, to a method and system for determining a channel model for wireless communication systems.

### BACKGROUND

In 5G wireless communication systems, the Channel Model is a mathematical model used to simulate the behavior of the wireless communication channel between the transmitter and the receiver. It describes the physical characteristics of the wireless channel, such as path loss, shadowing, multipath fading, delay spread, and Doppler shift. The Channel Model is essential for designing and evaluating the performance of wireless communication systems.

The 3rd Generation Partnership Project (3GPP) has defined several channel models for different use cases, environments, and frequencies. These channel models are based on empirical measurements, statistical models, and simulations. Some of the 3GPP defined channel models are: Urban Macro (UMa): Suitable for modeling outdoor-to-indoor scenarios in densely populated urban areas with large macrocell base stations; Urban Micro (UMi): Suitable for modeling outdoor-to-indoor scenarios in urban areas with small cells and microcells; Rural Macro (RMa): Suitable for modeling rural areas with large macrocells; Rural Micro (RMi): Suitable for modeling rural areas with small cells; Indoor Hotspot (InH): Suitable for modeling indoor scenarios with high user density and small cells.

The Channel Model is determined based on the characteristics of the wireless channel in a specific environment. The determination of the Channel Model involves various factors, such as frequency range, antenna height, terrain, building materials, and user mobility. The Channel Model can be estimated using empirical measurements, statistical models, and simulations. In a network, the Channel Model is typically determined by the network operator or the device manufacturer using measurements or simulations in the target environment. The Channel Model is then used for network planning, optimization, and evaluation.

There are several disadvantages of the current channel model determination methods, including such as limited Accuracy. The accuracy of the current channel model determination methods is limited by several factors, such as the availability and quality of measurement data, the complexity of the channel environment, and the accuracy of the modeling assumptions. This can result in inaccurate channel models, which can lead to suboptimal network design and performance.

Ray tracing a channel model determination method that can be used to estimate the wireless channel characteristics. It is a simulation-based method that is based on the principles of optics and electromagnetic theory. Ray tracing simulates the propagation of electromagnetic waves in the physical environment by tracing the path of individual rays from the transmitter to the receiver. In a ray tracing simulation, the physical environment is modeled as a 3D geometric space, and the transmitter and receiver are placed in the model at their respective locations. The simulation software then calculates the path of the electromagnetic waves as they travel through the environment and interact with objects such as buildings, trees, and other obstacles. The ray tracing method can provide high accuracy channel models, as it takes into account the detailed physical environment and the effects of reflections, diffraction, and scattering. However, it can also be computationally intensive and requires specialized software and expertise. The accuracy of the ray tracing method depends on the accuracy of the model geometry, the number of rays traced, and the accuracy of the electromagnetic wave propagation models used in the simulation. Developing accurate ray tracing models requires specialized software and expertise, which can be expensive and time-consuming. This can make it challenging for smaller network operators or device manufacturers to obtain accurate channel models using this method. Further, ray tracing simulations can be computationally intensive, especially for large and complex environments with many objects and reflections. This can result in long simulation times, which can limit the ability to explore different scenarios and model a wide range of environments.

All the problems mentioned above have made it necessary to make an innovation in the relevant technical field as a result.

### SUMMARY

The present invention relates to method and system to eliminate the above-mentioned disadvantages and bring new advantages to the relevant technical field.

An object of the invention is providing a method for estimating channel model with increased accuracy.

Another object of the invention is providing a method for estimating channel model with reduced cost and system resources.

To achieve all the objects mentioned above and that will emerge from the following detailed description, the present invention relates to method for estimating channel model of a wireless communication system. Accordingly, it is characterized in that including the steps of receiving and recording predetermined metrics over a first time period; processing recorded metrics using a machine learning algorithm to predict metrics for a second time period that is later than the first time period; accessing a database having predetermined metric thresholds; determining a channel model based on metric thresholds and future metrics using a classifier algorithm. Thus, model estimation accuracy is increased.

A possible embodiment of the invention is characterized in that including the step of; receiving and recording predetermined metrics over the second time period; comparing recorded metrics within second time period and future metrics predicted for second time period; feeding deviations back to first machine learning algorithm.

The present invention also relates to a channel model estimation system for estimating channel model of a wireless communication system. Accordingly, it is characterized in that including a management interface and at least two sub-interfaces; where sub-interfaces are hierarchically associated with each other and management interface is at the top of the hierarchy; sub-interfaces are configured to realize steps of receiving and recording predetermined metrics over a first time period; processing recorded metrics using a machine learning algorithm to predict metrics for a second time period that is later than the first time period; accessing a database having predetermined metric thresholds; determining a channel model based on metric thresholds and future metrics using a classifier algorithm; transmitting at least some of the collected metrics, estimated metrics and estimated channel model to another sub-interface or to management interface whichever is hierarchically one level above itself. Thus, the need for processing big data is reduced and processing is made at different hierarchical interface layers.

A possible embodiment of the invention is characterized in that it includes a transmitter point interface; said transmitter point interface includes a processor unit and a metric monitoring system for receiving metrics from user equipment (UE).

Another possible embodiment of the invention is characterized in that said transmitter point is provided on radio access network.

Another possible embodiment of the invention is characterized in that the transmitter point interface includes at least one transmitter point (TP).

Another possible embodiment of the invention is characterized in that it includes a transmitter cluster interface configured to receive metrics and estimated models from transmitter point interface.

Another possible embodiment of the invention is characterized in that it includes an environment interface configured to receive metrics and estimated models from transmitter cluster interface.

Another possible embodiment of the invention is characterized in that it includes a regional interface configured to receive metrics and estimated models from environment interface.

Another possible embodiment of the invention is characterized in that transmitter point interface is configured to receive speed trend information from UE and configured to transmit said speed trend information to transmitter cluster interface; the transmitter cluster interface is configured to send speed trend information to environment interface and environment interface is configured to process speed trend information and other metrics provided from transmitter cluster interface and adjust dataset granularity for related environment.

### BRIEF DESCRIPTION OF THE DRAWINGS

FIG. 1 is a drawing illustrating top schematic view of the system.

FIG. 2 is another schematic view of the system.

### REFERENCE NUMBERS GIVEN IN THE FIGURES

10 Channel model estimation system
100 Main network control unit
110 Management interface
120 Sub-interface
121 Regional interface
122 Environment interface
123 Transmitter cluster interface
124 Transmitter point interface
124a Processor unit
124b Metric monitoring systems
200 UE

### DETAILED DESCRIPTION OF THE EMBODIMENTS

In this detailed description, the subject matter is explained with references to examples without forming any restrictive effect only in order to make the subject more understandable.

Reference is made to Third Generation Partnership Project (3GPP) system, in accordance with embodiments of the present disclosure. The present application employs abbreviations, terms and technology defined in accord with Third Generation Partnership Project (3GPP) technology standards, including the following standards and definitions. 3GPP technical specifications (TS) and technical reports (TR) incorporated in their entirety by reference herein, define the related terms and architecture reference models that follow.
UE: USER EQUIPMENT
TP: Transmitter point/Transmission point
RAN: Radio Access Network
CN: Core Network
RRC: Radio Resource Connection
E-UTRAN: Evolved Universal Terrestrial Radio Access Network,
UTRAN: Universal Terrestrial Radio Access Network
GERAN: GSM (Global System for Mobile Communications) EDGE (Enhanced Data rates for GSM Evolution) Radio Access Network
eNodeB: base station
CSI: Channel State Information
SS: Synchronization Signal
RS: Reference Signal
DL: Downlink
UL, Uplink
PRS: Positioning Reference Signal
PSBCH: Physical Sidelink Broadcast Channel
NR: New Radio
E-UTRA: Evolved Universal Terrestrial Radio Access
SRS: sounding Reference Signal
AOD: Angle of Departure
AOA: Angle of Arrival
ZOD: Zone of Departure
ZOA: Zone of Arrival

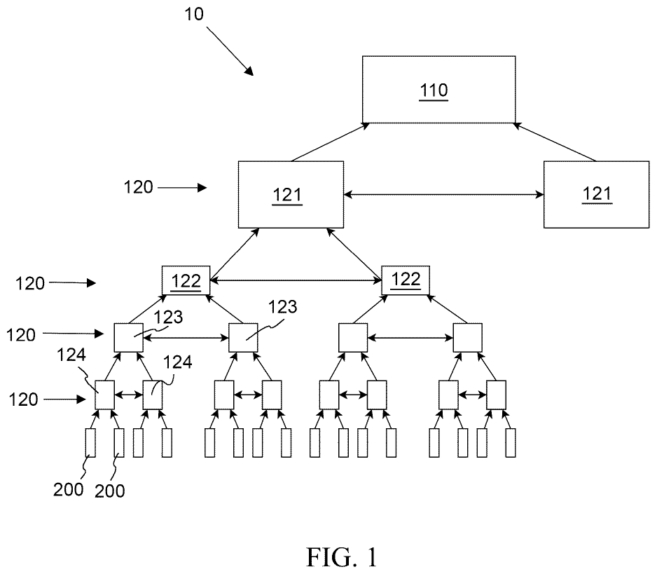

Referring to FIG. 1, present invention is a channel model estimation system (10) including a management interface (110) and plurality of sub-interfaces (120). Management interface (110) controls sub-interfaces (120). Sub-interfaces (120) are provided hierarchically. In other words, a sub-interface (120) controls another sub interface that is on one lower level in the hierarchy if there is one. A sub-interface (120) is controlled by another sub-interface (120) that is on one higher level in the hierarchy if there is one. Management interface (110) is at the top of hierarchy.

Each interfaces has access to predetermined channel models. Each interface collects predetermined metrics over a first time period. Each interface then generates predicted metrics using a first machine learning algorithm for a second time period that is later than said first time period based on collected metrics. A database is provided that has predetermined metric thresholds. Said metric thresholds may be maximum and minimum possible values of metrics calculated using historical data. Each interface determines a channel model based on future metrics and metric thresholds using a classifier algorithm. Determined channel model is then fed to an upper level of the hierarchy and other members of the interface. In the second time period metrics are collected. Future metrics predicted for second time period and real metrics collected during second time period are compared and deviations are fed to first machine learning algorithm for improving algorithm further.

Machine learning algorithms are well known in the art. Machine learning may be defined as computational methods that enable a computer to learn and improve its performance on a specific task without being explicitly programmed. Machine learning algorithms typically involve the use of statistical models and algorithms to identify patterns and relationships in large datasets. These algorithms use these patterns and relationships to make predictions or decisions about new data. Any suitable machine learning algorithm may be used to predict future metrics.

In some embodiments, first machine learning algorithm may include neural networks, decision trees, support vector machines, and random forests, among others. These algorithms may be trained using a combination of simulated and measured data, and may be optimized for specific metrics.

Classifier algorithms are well known in the art. The classifier algorithm can be defined as computational methods that enable a computer to classify data into one or more categories or classes based on patterns and relationships in the data. Classifier algorithms are commonly used in machine learning and artificial intelligence applications, and are designed to identify features in input data and assign the data to specific categories or classes based on those features. Classifier algorithm may include decision trees, k-nearest neighbor algorithms, support vector machines, and neural networks, among others.

Channel model estimation system (10) includes transmitter point interfaces (124). Transmitter point interface (124) is provided in Radio Access Network (RAN). Each transmitter point interface (124) includes at least one transmitter point (TP). A TP can be defined as a hardware component of a wireless communication system that is responsible for transmitting wireless signals over the air interface to one or more wireless receivers. The transmission point may include one or more wireless transmitters, antennas, and signal processing components, and may be connected to a larger network or system, such as a cellular network or a local area network. In particular, a TP in a wireless communication system may be responsible for transmitting various types of wireless signals, including voice, data, and video signals, as well as control signals for managing the network and optimizing performance. The TP may use various modulation and coding schemes, transmission power levels, and antenna configurations to optimize the wireless signal transmission and reception. The transmission point in a wireless communication system may include a base station, access point, or other wireless transmitter that is connected to a wired network or system, as well as dedicated signal processing components, such as digital signal processors or application-specific integrated circuits. The transmission point may also include software modules for controlling the operation of the hardware components, and for implementing various network protocols and algorithms to optimize performance and manage network resources.

When there are more than one transmitter point is provided, one of the transmitter points is assigned as the main transmitter point. Transmitter point interface (124) includes a processing unit. Processor unit (124a) is responsible for executing instructions and performing calculations on data. Processing unit may include one or more microprocessors, digital signal processors, or other specialized processing units, as well as dedicated memory modules and input/output interfaces. The processing unit may also include software modules for executing various algorithms and protocols, as well as firmware for controlling the operation of the hardware components. Transmitter point interface (124) includes metric monitoring systems (124b). Metric monitoring systems (124b) may include receivers and processing units for receiving wireless signals and determining metrics related to received wireless signals. Metric monitoring systems (124b) may include receivers for signals that has metrics. Metric monitoring systems (124b) are configured to communicate with User Equipment (200) in order to collect metrics relating to User Equipment (200). Transmitter point interface (124), channel model may aim at least one of the following requirements: Ultra high mobility, Ultra high precision, Ultra low energy, Ultra massive connectivity, Ultra large coverage.

Transmitter point interfaces (124) are configured to communicate with other nodes in the same interface.

Transmitter point interface (124), has access to predetermined channel models relating to its requirements. Such channel models may include customized channel models based on the area covered by the transmitter points. Transmitter point interface (124) collects predetermined metrics from UEs (200) over a first time period. Such transmitter point-based metrics may include UE Rx-Tx time difference, DL reference signal time difference, Received Signal Strength Indicator (RSSI), CSI reference signal received quality, reference signal received power (RSRP), etc. Transmitter point interface (124) then generates predicted metrics using the first machine learning algorithm for a second time period that is later than said first time period based on collected metrics. Transmitter point interface (124) determines a channel model based on future metrics and metric thresholds using a classifier algorithm. Determined channel model is then fed to an upper level of the hierarchy and other members of the interface. In the second time period metrics are collected. Future metrics predicted for second time period and real metrics collected during second time period are compared and deviations are fed to first machine learning algorithm for improving algorithm further.

User Equipment (200) may be mobile phones, computers, sensor devices, wireless connected devices of vehicles such as train, car etc. User Equipment (200) may require wireless communication that satisfies Ultra Broadband (AR/VR, hologram, 4K video streaming etc); Ultra High Mobility (connected cars, trains); Ultra High Precision (Mission critical applications etc.); Ultra Low Energy (Industrial sensors, agricultural sensors etc.); Ultra Massive Connectivity (Industrial, agricultural sensors etc.) and Ultra Large Coverage.

Each interface feeds metrics to the interface in the one upper level of the hierarchy.

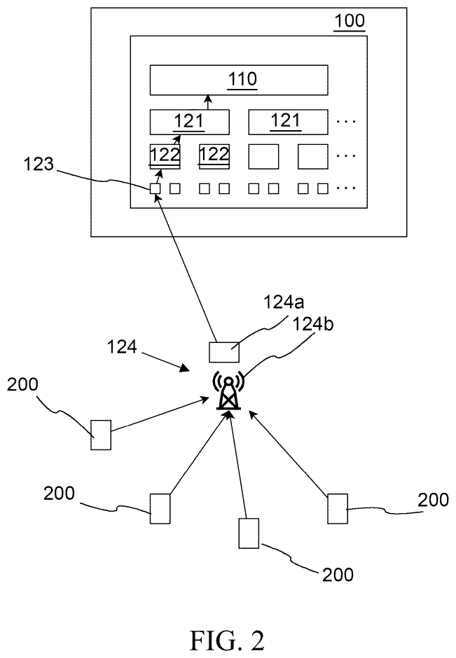

Channel model estimation system (10) includes transmitter cluster interfaces (123). Referring to FIG. 2, transmitter cluster interface (123) may be provided in a main network control unit (100) that is connected to transmission points belonging to transmitter point interface (124). Transmitter cluster interface (123) is provided in core network. Transmitter cluster interface (123), has access to predetermined channel models relating to its requirements. Such channel models may include customized and grouped channel models with similar coverage characteristics based on the area covered by transmitter points in different locations. Transmitter cluster interface (123) collects predetermined metrics from transmitter point interface (124) over a first time period. Such transmitter cluster-based metrics may include secondary synchronization signal (SSS) transmit power, transmitter point Rx-Tx time difference, timing advance, etc. Transmitter cluster interface (123) then generates predicted metrics using the first machine learning algorithm for a second time period that is later than said first time period based on collected metrics. Transmitter cluster interface (123) determines a channel model based on future metrics and metric thresholds using a classifier algorithm. Determined channel model is then fed to an upper level of the hierarchy and other members of the interface. In the second time period metrics are collected. Future metrics predicted for second time period and real metrics collected during second time period are compared and deviations are fed to first machine learning algorithm for improving algorithm further.

Each transmitter cluster interface (123) covers at least one transmitter point interface (124). Each transmitter cluster interface (123) may include transmitter point interfaces (124) that covers following areas such as city centers, suburbs, hinterlands, rural areas, highway, train track, subway track, security areas.

Channel model estimation system (10) includes environment interface (122). Referring to FIG. 2, environment interface (122) may be provided in a main network control unit (100). Environment interface (122) provided in core network. Environment interface (122), has access to predetermined channel models relating to its requirements. Such channel models may include UMi, Uma etc. Environment interface (122) collects predetermined metrics from transmitter cluster interfaces (123) over a first time period. This type of interface may include metrics created by augmentation of single or multiple transmitter point interface metrics. Environment interface (122) then generates predicted metrics using the first machine learning algorithm for a second time period that is later than said first time period based on collected metrics. Environment interface (122) determines a channel model based on future metrics and metric thresholds using a classifier algorithm. Determined channel model is then fed to an upper level of the hierarchy and other members of the interface. In the second time period metrics are collected. Future metrics predicted for second time period and real metrics collected during second time period are compared and deviations are fed to first machine learning algorithm for improving algorithm further. In a possible embodiment transmitter point interface (124) collects speed trend information from UE (200). Transmitter points transmits speed trend information to transmitter cluster interface (123). Transmitter cluster interface (123) transmits speed trend to environment interface (122). Environment interface (122) processes speed trend information and other metrics provided from transmitter cluster interface (123) to decide how much dataset granularity will be used for related environment. If the conditions in an environment Interface (122) change rapidly, the dataset with high granularity will be used. Otherwise, the dataset with low (110) will be used.

Dataset granularity can be defined as the level of detail or resolution at which data is collected and stored in a dataset. For example, wireless channel data may be collected at a very high granularity, with measurements taken at very short intervals, in order to accurately model the wireless channel characteristics and optimize network performance. On the other hand, network traffic data may be collected at a lower granularity, with aggregate statistics collected over longer time intervals, in order to reduce the volume of data and improve processing efficiency.

Environment interface (122) covers at least one transmitter cluster interface (123).

Channel model estimation system (10) includes regional interface (121). Referring to FIG. 2, regional interface (121) may be provided in a main network control unit (100). Regional interface (121) provided in core network. Regional interface (121), has access to predetermined channel models relating to its requirements. Such channel models may include . . . etc. Regional interface (121) collects predetermined metrics from environment interfaces (122) over a first time period. Such metrics may include This type of interface may include metrics created by augmentation of single or multiple environment interface metrics. Regional interface (121) then generates predicted metrics using the first machine learning algorithm for a second time period that is later than said first time period based on collected metrics. Regional interface (121) determines a channel model based on future metrics and metric thresholds using a classifier algorithm. Determined channel model is then fed to an upper level of the hierarchy and other members of the interface. In the second time period metrics are collected. Future metrics predicted for second time period and real metrics collected during second time period are compared and deviations are fed to first machine learning algorithm for improving algorithm further.

Each regional interfaces (121) covers at least one environment interface (122). Regional interfaces (121) covers areas such as City, County, Neighborhood.

Main interface is hierarchically at top. It is provided on core network. It is also provided on a main network control unit (100). Main interface has access to predetermined channel models relating to its requirements. Such channel models may include . . . etc. Main interface collects predetermined metrics from regional interfaces (121) over a first time period. This type of interface may include metrics created by augmentation of single or multiple regional interface metrics. Regional interface (121) then generates predicted metrics using the first machine learning algorithm for a second time period that is later than said first time period based on collected metrics. Regional interface (121) determines a channel model based on future metrics and metric thresholds using a classifier algorithm. Determined channel model is then fed to an upper level of the hierarchy and other members of the interface. In the second time period metrics are collected. Future metrics predicted for second time period and real metrics collected during second time period are compared and deviations are fed to first machine learning algorithm for improving algorithm further. Thus, management interface (110) does not compute all the big data but hierarchically fed with data and determined channel models.

Three UE states are defined in 3GPP R17. Invention considers the metrics available for RRC_INACTIVE and RRC_CONNECTED states. The definitions of states are as follows: RRC_INACTIVE: UE moves to this mode from RRC_CONNECTED mode. It is connected but inactive mode of UE. In this mode UE maintains RRC connection and at the same time minimizes signaling and power consumption. RRC_CONNECTED: UE remains in connection with the 5G-RAN/5GC in this mode.

In each states, the system considers metrics that are available for Intra-Frequency, Inter-Frequency and Inter-RAT. The 3GPP definitions are as follows:

Intra-Frequency: Intra-frequency mobility management is implemented by handovers between E-UTRAN cells using the same frequency. A network may use the same frequency in different cells, and therefore the eNodeB needs to support intra-frequency handovers within the network. Inter-Frequency: Inter-frequency mobility management is implemented by handovers between E-UTRAN cells using the different frequencies. A network may use different frequencies in different geographical areas, and therefore the eNodeB needs to support inter-frequency handovers within the network.

Inter-RAT: Involves mobility management between E-UTRAN and UTRAN and mobility management between E-UTRAN and GERAN.

The metrics described in this patent application may vary according to network needs and structures. Such metrics are given below as examples:

SS-RSRP (SS reference signal received power): The linear average over the power contributions (in [W]) of the resource elements that carry secondary synchronization signals.

CSI-RSRP (CSI reference signal received power): The linear average over the power contributions (in [W]) of the resource elements of the antenna port(s) that carry CSI reference signals configured for RSRP measurements within the considered measurement frequency bandwidth in the configured CSI-RS occasions.

DL PRS-RSRP (DL PRS reference signal received power): The linear average over the power contributions (in [W]) of the resource elements that carry DL PRS reference signals configured for RSRP measurements within the considered measurement frequency bandwidth.

PSBCH-RSRP (PSBCH reference signal received power): The linear average over the power contributions (in [W]) of the resource elements that carry demodulation reference signals associated with physical sidelink broadcast channel (PSBCH).

DL PRS-RSRPP (DL PRS reference signal received path power): The power of the linear average of the channel response at the i-th path delay of the resource elements that carry DL PRS signal configured for the measurement, where DL PRS-RSRPP for the 1st path delay is the power contribution corresponding to the first detected path in time.

SS-SINR (SS signal-to-noise and interference ratio): The linear average over the power contribution (in [W]) of the resource elements carrying secondary synchronisation signals divided by the linear average of the noise and interference power contribution (in [W]).

CSI-SINR (CSI signal-to-noise and interference ratio): The linear average over the power contribution (in [W]) of the resource elements carrying CSI reference signals divided by the linear average of the noise and interference power contribution (in [W]).

SS-RSRQ (SS reference signal received quality): The ratio of NxSS-RSRP/NR carrier RSSI, where N is the number of resource blocks in the NR carrier RSSI measurement bandwidth. The measurements in the numerator and denominator shall be made over the same set of resource blocks.

CSI-RSRQ (CSI reference signal received quality): The ratio of NxCSI-RSRP to CSI-RSSI, where N is the number of resource blocks in the CSI-RSSI measurement bandwidth. The measurements in the numerator and denominator shall be made over the same set of resource blocks.

RSSI (Received Signal Strength Indicator): The linear average of the total received power (in [W]) observed only per configured OFDM symbol and in the measurement bandwidth indicated by higher layers or corresponding to the channel bandwidth.

RSTD (Reference signal time difference for E-UTRA): The relative timing difference between the E-UTRA neighbor cell j and the E-UTRA reference cell i.

DL RSTD (DL reference signal time difference): the DL relative timing difference between the Transmission Point (TP) [18]j and the reference TP i defined as T_{subframeRxj}−T_{SubframeRxi} UE GNSS Timing of Cell Frames for UE positioning for E-UTRA: The timing between E-UTRA cell j and a GNSS-specific reference time for a given GNSS (e.g., GPS/Galileo/Glonass system time).

UE Rx-Tx time difference: The UE Rx-Tx time difference is defined as T_{UE-RX}−T_{UE-TX} SS-RSARP (SS reference signal antenna relative phase): the difference of the average phase of the receive signals on the resource elements that carry secondary synchronization signals (SS) received by the reference individual receiver branch (Rx0) and the average phase of the receive signals on the resource elements that carry secondary synchronization signals (SS) received by one other individual receiver branch (Rx1 . . . Rxn).

gNB Rx-Tx time difference: The gNB Rx-Tx time difference is defined as T_{gNB-RX}−T_{gNB-TX} UL AoA (UL Angle of Arrival): The estimated azimuth angle and vertical angle of a UE with respect to a reference direction.

UL SRS-RSRP (UL SRS reference signal received power): The linear average of the power contributions (in [W]) of the resource elements carrying sounding reference signals (SRS). UL SRS RSRP shall be measured over the configured resource elements within the considered measurement frequency bandwidth in the configured measurement time occasions.

UL SRS-RSRPP (UL SRS reference signal received path power): The power of the linear average of the channel response at the i-th path delay of the resource elements that carry the received UL SRS signal configured for the measurement, where UL SRS-RSRPP for 1st path delay is the power contribution corresponding to the first detected path in time T_{ADV} (Timing advance): The time difference T_{ADV}=(T_{gNB-RX}−T_{gNB-TX}).

Non-3gpp metrics such as: Path loss, Shadow fading, Delay spread, AOD, AOA, ZOD, ZOA

The scope of protection of the invention is specified in the attached claims and cannot be limited to those explained for sampling purposes in this detailed description. It is evident that a person skilled in the art may exhibit similar embodiments in light of the above-mentioned facts without drifting apart from the main theme of the invention.

What is claimed is:

1. A method for estimating a channel model of a wireless communication system, comprising:
receiving and recording predetermined metrics over a first time period;
processing recorded metrics using a machine learning algorithm to predict metrics for a second time period that is later than the first time period;
accessing a database having predetermined metric thresholds; and
determining a channel model based on metric thresholds and future metrics using a classifier algorithm.

2. The method according to claim 1, further comprising: receiving and recording the predetermined metrics over the second time period; comparing the recorded metrics within the second time period and the future metrics predicted for the second time period; and feeding deviations back to first machine learning algorithm.

3. A channel model estimation system for estimating a channel model of a wireless communication system, comprising a management interface and at least two sub-interfaces; wherein the at least two sub-interfaces are hierarchically associated with each other and a management interface is at a top of the hierarchy; the at least two sub-interfaces are configured to realize steps of:
receiving and recording predetermined metrics over a first time period;
processing recorded metrics using a machine learning algorithm to predict metrics for a second time period that is later than the first time period;
accessing a database having predetermined metric thresholds;
determining a channel model based on metric thresholds and future metrics using a classifier algorithm; and
transmitting at least some of the collected metrics, estimated metrics and estimated channel model to another sub-interface or to management interface whichever is hierarchically one level above itself.

4. The channel model estimation system according to claim 3, further comprising: a transmitter point interface; wherein the transmitter point interface comprises a processor unit and a metric monitoring system for receiving metrics from user equipment (UE)

5. The channel model estimation system according to claim 3, wherein the transmitter point is provided on radio access network.

6. The channel model estimation system according to claim 3, wherein the transmitter point interface comprises at least one transmitter point (TP).

7. The channel model estimation system according to claim 4, further comprising a transmitter cluster interface configured to receive metrics and estimated models from the transmitter point interface.

8. The channel model estimation system according to claim 7, further comprising an environment interface configured to receive the metrics and the estimated models from the transmitter cluster interface.

9. The channel model estimation system according to claim 8, further comprising a regional interface configured to receive the metrics and the estimated models from the environment interface.

10. The channel model estimation system according to claim 9, wherein the transmitter point interface is configured to receive speed trend information from UE and configured to transmit the speed trend information to the transmitter cluster interface; the transmitter cluster interface is configured to send the speed trend information to the environment interface, and the environment interface is configured to process the speed trend information and other metrics provided from the transmitter cluster interface and adjust dataset granularity for related environment.
